(19) United States
(12) Patent Application Publication
(10) Pub. No.: US 2026/0057356 A1
(43) Pub. Date: Feb. 26, 2026

(54) DIGITAL TOKEN ESCROW SYSTEM FOR A MARKET-BASED QUEUEING SYSTEM

(71) Applicant: American Express Australia Limited, Sydney (AU)

(72) Inventors: Lucky BIMOLAKSONO, Sydney (AU); Dean Ernest Arthur NICOLSON, Sydney (AU)

(73) Assignee: American Express Australia Limited, Sydney (AU)

(21) Appl. No.: 18/813,574

(22) Filed: Aug. 23, 2024

(51) Int. Cl. G06Q 20/10; G06Q 20/38

(52) U.S. Cl. CPC G06Q 20/10; G06Q 20/386

(57) ABSTRACT

Disclosed herein are method, system, and computer product aspects for queue management and facilitating transactions based on an exchange of queue position. This may include a physical change in relative queue position between queuing devices and/or an exchange of queue position in an electronic queue. Upon exchanging queue positions, the queuing devices may conduct a transaction to transfer value for the exchanged position. The exchange of queue positions may include vehicles traveling on a roadway and exchanging positions in traffic, exchanging positions between mobile device users standing in a line, and/or exchanging positions in an electronic queue. Monetary funding may be transferred between the queuing devices when exchanging positions in the queue. A queue management system may generate a suggested positional exchange amount based on user parameters, conditions, and/or preferences for interacting with the queue.

### BACKGROUND

### Field

This field is generally related to managing queues and facilitating transactions based on an exchange of queue position.

### Related Art

As technology continues to evolve and as society becomes increasingly fast-paced, different individuals may have different desires for how they wish to spend their time. One issue that many time-sensitive individuals face is waiting in a queue or waiting in traffic. Such individuals would view time spent in a queue or in traffic as a time sink or a waste of time. These individuals may wish to avoid and/or minimize the amount of time spent in the queue or in traffic. This issue may become even more pronounced as autonomous vehicles become more widely adopted. For example, users in autonomous vehicles may join queues in order to travel to their desired destinations.

In contrast, less time-sensitive individuals may be willing to wait for a longer amount of time in the queue or in traffic if incentivized to do so. Currently, there are no known mechanisms or technological solutions for reducing the time spent in a queue or in traffic or balancing the different interests of individuals. Further, there are no mechanisms in place to facilitate the exchange of queue positions and/or to facilitate transactions between devices exchanging positions.

### BRIEF SUMMARY

Disclosed herein are system, apparatus, device, method, and/or computer program product aspects, and/or combinations and sub-combinations thereof for managing queues and facilitating transactions based on an exchange of queue position. This may include a physical change in relative queue position between queuing devices and/or an exchange of queue position in an electronic queue. Upon exchanging queue positions, the queuing devices may conduct a transaction to transfer value for the exchanged queue position.

In some aspects, a queue management system may facilitate transactions and/or microtransactions between queuing devices associated with users in a queuing system. The transactions between the queuing devices may be microtransactions, which may include transactions in which the transaction amount is lower than the processing cost. The transactions may also include transaction amounts that are equal to or higher than the processing cost. A transaction amount may be decided upon between the queuing devices to trade relative positions. This position trading may occur in different contexts. For example, the queuing devices may be located in vehicles and trade relative geographical positions along a road or highway. In some aspects, the queuing devices may be communication devices capable of being held by a user in a physical line, such as a ticket line, a ride line, a checkout line, and similar physical queuing lines where users may trade positions in the physical line. For example, the queuing devices may be a user device such as a mobile communication device, a tablet, a personal digital assistant (PDA), or another suitable portable or wearable communication device. In aspects, the queuing devices may be or part of computing systems of vehicles. In this disclosure vehicle is construed broadly and can include a car, a train, a bus, a motorcycle, a boat, an airplane, a bicycle or e-bike, etc. The term vehicle is also meant to include an autonomous vehicle.

In some aspects, the position trading may be in the form of an electronic queue. The trading of positions may be a numeric position in the queue. For example, this may apply in an electronic ticketing system where users are attempting to purchase tickets to an event.

Once the users have traded positions in the queuing environment, a transaction can occur between the queuing devices and/or queue system accounts corresponding to the queuing devices. The transaction between the queuing devices are settled once a verified movement has occurred. The change in position may be determined based on the context of the queuing environment. For example, when detecting a relative physical change in position, verification of the movement may be based on a physical measurement. This physical change in location may be, for example, when one queuing device moves in front of another queuing device. In an electronic queue, a numeric consideration may be used to identify the change in position. For example, one queuing device moves to a lower, more advantageous, numerical value in the queueing environment. The change in position may be verified by each queuing device participating in the exchange, queuing devices not participating in the exchange, and/or the queue management system. Following verification of the movement and/or the change in position, the queuing devices may conduct a transaction to transfer value in exchange for the change in queue position.

In aspects, the queue management system may also account for devices that are not registered with the queue management system. For example, the above aspects assume the queuing devices are registered with the queue management system such that these devices can perform the aforementioned transactions seamlessly with one another. The queuing devices that are registered with the queue management system have knowledge of one another and can communicate via the queue management system through protocols and interfaces to decide upon transaction amounts when trading relative positions. However, there may be instances when a registered queuing device encounters a device that is not registered with the queue management system. In aspects, the queue management system can account for interactions with these unregistered devices and further have mechanisms that can encourage these unregistered devices to become registered devices. The mechanisms implemented by the queue management system to account for these interactions will be discussed further below.

### BRIEF DESCRIPTION OF THE DRAWINGS

The accompanying drawings are incorporated herein and form a part of the specification.

FIG. 1A depicts a block diagram of a physical queuing environment, according to aspects.

FIG. 1B depicts a block diagram of an electronic queuing environment, according to aspects.

FIG. 2 depicts a block diagram of a queuing environment that accounts for unregistered devices, according to aspects.

FIG. 3 depicts a flowchart illustrating a method of operating a queue management system to account for unregistered devices, according to aspects.

FIG. 4 depicts an example computer system used to implement the queue management system, according to aspects.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method, and/or computer program product aspects, and/or combinations and sub-combinations thereof, for managing positions in a queue and settling transactions after a verified relative movement in position has occurred. In some aspects, queuing devices may settle transactions based on an exchange of queue position. This may include a physical change in relative queue position between queuing devices and/or an exchange of queue position in an electronic queue. Upon exchanging queue positions, the queuing devices may conduct a transaction to transfer value for the exchanged queue position.

To facilitate the transactions, a queuing device may load a user's queue system account. The queue system account may be stored in an account database managed by the queue management system and/or include user preferences, payment information associated with a digital wallet service, and identifying information of the queuing device. The user of the queuing device may have previously registered with the queue management system.

After registration, the user may log into the queue system account via a user interface of the queuing management system. The previous user preferences, payment information, and/or queuing device identifier may then be loaded into the memory of the queuing device. The user preferences may be modified at the user interface of the queuing device. The queuing device may also allow the user to indicate the queue they are joining with the queuing device. In some embodiments, the queuing device and/or the queuing management system may use GPS information, position sensor data, and/or detection data from other queuing devices to determine a queue for a particular queuing device. The user may automatically join the detected and/or suggested queue.

The queue management system may use the user preferences, position data, and/or queue information as inputs for the user suggestion system. The user suggestion system may suggest the queuing device exchange positions in the queue with another queuing device in the same queue, for a suggested transaction amount. The suggested transaction amount may be determined by the queue management system based on the user preferences associated with the queuing device and queue system account. Additionally, the transaction may be a microtransaction to allow multiple successive transactions and/or exchanges in position in the queue with various other queuing devices in the same queue. Microtransactions may allow the queuing device to increase the position in the queue multiple times by exchanging positions with multiple different users.

The suggested exchange in position and corresponding transaction amount may be manually accepted by the user at the user interface of the queuing device or the user may allow the queuing device to automatically accept suggestions. The user may toggle on and off manual or automatic acceptance of suggestions at the user interface. The toggle may allow the user to change preferences while in the queue if desired.

Once the transaction amount is accepted, the queuing devices may exchange positions in the queue. To determine when the exchange in position occurs for physical queuing devices, sensors of the queuing device may be used. For example, a first queuing device may exchange positions with a second queuing device. The exchange in position may be confirmed by the first queuing device, second queuing device, or both queuing devices, depending on user preference. In some aspects, the verification method may depend on the type of queue and/or the queuing environment. For example, the user of the second queuing device may indicate whether their queuing device should confirm the exchange in position or rely solely on the determination by the first queuing device. The queuing device may automatically determine when the exchange in position occurs by using existing sensors or infrastructure of the queuing device to determine when the exchange occurs. Additionally, the user may indicate that they would like to manually confirm when the exchange in position has occurred at the user interface of the queuing device. As similarly described above, the user can toggle between automatic and manual confirmation of the exchange in position via the user interface. In some aspects, the queuing devices may use the same or separate modes of verification. For example, the first queuing device may use an automatic determination while the second queuing device may use a manual or automatic determination or may choose to rely on the determination of the first queuing device. Additionally, other queuing devices in the queue that are not associated with the specific transaction may determine whether the exchange in position has occurred and communicate the determination to the queue management system via the network.

In some aspects, the queuing devices may communicate directly with each other using the communication interface or communicate via the network, depending on the type of queue environment and user preference. In some aspects, the queuing devices may not communicate directly. Instead, the queuing devices may communicate with a queue management system. The queue management system may monitor the relative movement and/or positions of the queuing devices and/or facilitate the transactions.

In some aspects, after the queuing device determines the exchange in position in the queue has occurred, the transaction amount is settled between the queuing devices. Transactions may be settled through a digital wallet service. The queue system account associated with the queuing device may include digital wallet information. When the user registers or logs into their queue system account at the user interface of the queuing device, the queue system account information may be loaded into the device memory of the corresponding queuing device. The queuing devices may settle the transaction in real-time. In some aspects, the queuing devices may exchange digital wallet information and the transaction may be settled at a later time. For example, transactions may be settled when the queuing device has reached a particular point in the queue. An example of such a point may be once the queuing device has reached the front of a physical or electronic line or queue. In a vehicle, the settlement may occur when the queuing device has reached a particular destination and/or has connected to the queue management system via a network.

In some aspects, the queue may be a physical queue (e.g. a queuing device in a physical line). In some aspects, the queue may be an electronic queue (e.g. a queue for online sales). In the electronic queuing environment, the queuing devices may communicate via the network, as they are not in physical proximity to one another. Additionally, the exchange in position in the queue may be verified by queue management system rather than direct verification from the queuing devices.

In aspects, the queue management system can monitor the relative movement and/or positions of a queuing device with respect to a device that is not registered with the queue management system in order to facilitate transactions. For example, the queue management system can monitor a queuing device that is registered with respect to other devices that are not registered with the queue management system to determine what movements and/or exchanges in physical positions or changes numerically occur between the two devices. In aspects, if the queue management system determines that the unregistered device has yielded to the registered device, by for example performing a maneuver to cause the registered queuing device to obtain a more favorable position (either physically or electronically) relative to its previous position prior to the exchange, the queue management system can reward the unregistered device.

In aspects, the reward can include transferring an exchange amount from a first digital wallet corresponding to the first queuing device to a temporary storage for a user of the unregistered device to retrieve. In aspects, the exchange amount may be in the form of a value of a fiat currency, a digital currency, a coupon, or a credit. Because the unregistered device may not have its own digital wallet, the queue management system can store the exchange amount in a temporary storage for a user of the unregistered device to retrieve.

In aspects, in order to encourage users of the unregistered device to register the unregistered device with the queue management system and become part of the community of devices involved in the marketplace of transactions facilitated by the queue management system, the queue management system can obtain contact information of a user of the unregistered device. In aspects, the contact information can include at least e-mail address, a phone number, a social media account, a name, an address, or other identifying information of a user. In aspects, the contact information may be obtained via a public database, a governmental database, a private database, a data broker, and/or by crawling the Internet.

In aspects, based on the obtained contact information, the queue management system can generate a message to the user of the unregistered device, notifying the user of availability of the exchange amount to retrieve. In aspects, upon generating the message, the queue management system can transmit the message to the user of the unregistered device, or initiate transmission of the message to the user of the unregistered device via any appropriate means. For example, the message may be in the form of an e-mail, a phone call, a physical mail/correspondence, a push notification, or a Short Message Service (SMS) message. In aspects, the message can indicate to the user of the unregistered device that the exchange amount is ready for the user to retrieve. In aspects, the message can further include a hyperlink generated that the user can use to register with the queue management system. The user of the unregistered device can interact with the hyperlink by clicking or following the link to a registration page to register the unregistered device. Once registered, the user can retrieve the exchange amount. In aspects, as a part of the registration, the user may be assigned a digital wallet by the queue management system. In aspects, the user can link/connect the digital wallet to a financial account of an institution, such that the exchange amount and further amounts obtained from future transactions may be transferred to the financial account. Various aspects of these features will now be discussed with respect to the corresponding figures.

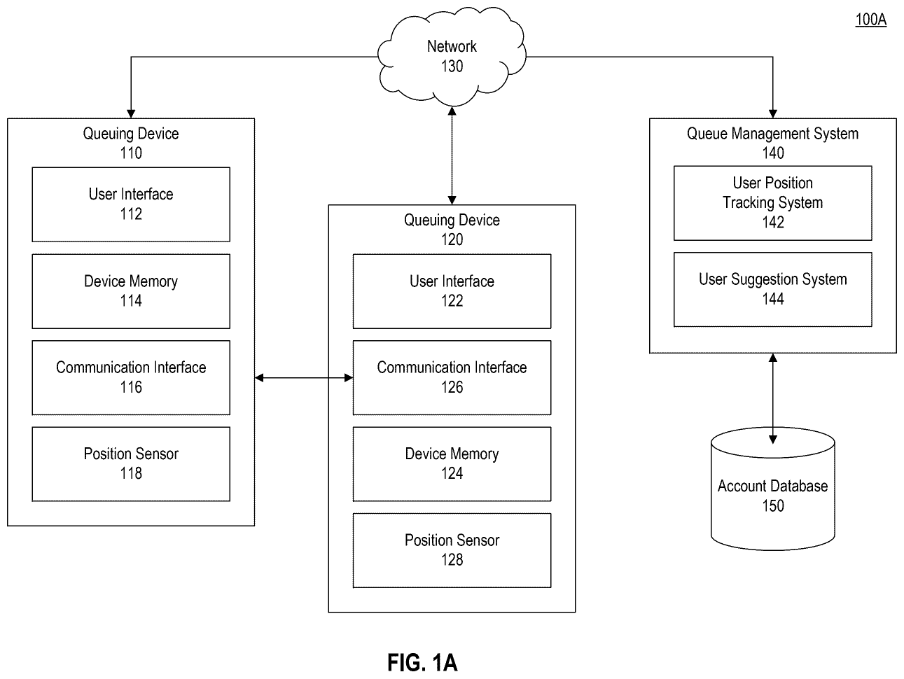

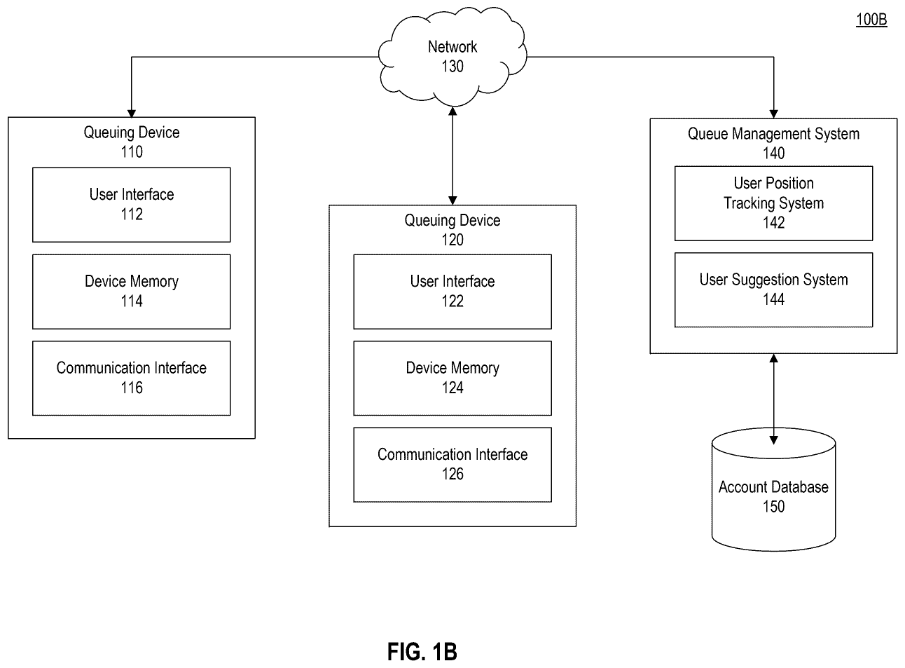

FIG. 1A depicts a block diagram of a physical queuing environment 100A, according to aspects. Physical queueing environment 100A includes queuing devices 110 and 120, network 130, queue management system 140, and account database 150.

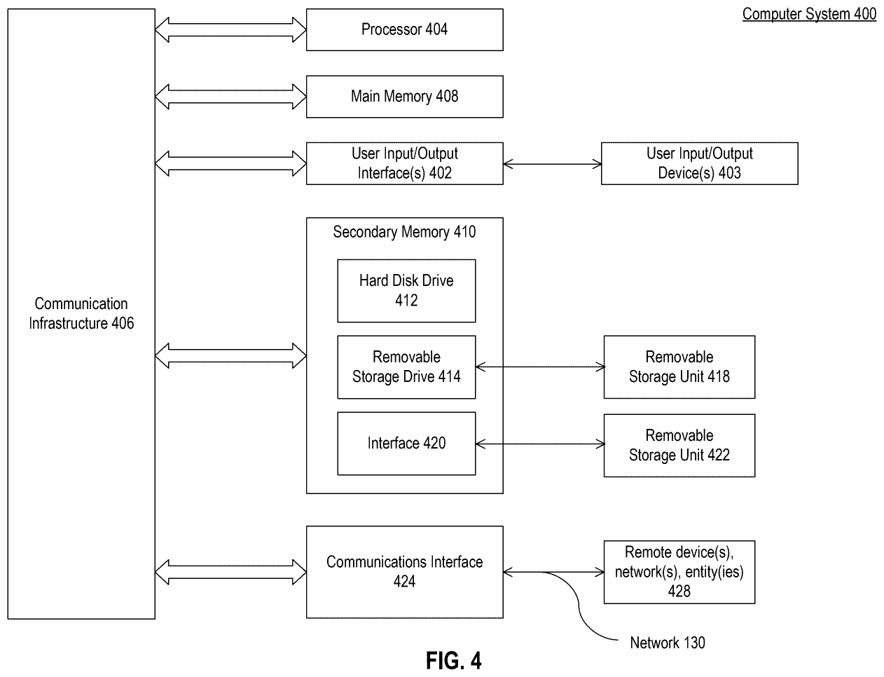

In physical queuing environment 100A, queuing devices 110 and 120 may be a computer system such as computer system 400 described with reference to FIG. 4. For example, queuing devices 110 and 120 may be a vehicle computer system, smart phone, smart watch, laptop or notebook computer, netbook, tablet, personal digital assistant (PDA), and/or other mobile communication devices, which are wearable or portable. Queuing devices 110 and 120 may include user interface 112 and 122, device memory 114 and 124, communication interface 116 and 126, and position sensor 118 and 128, respectively.

In some aspects, the user registers a queue system account or logs into an existing queue system account on queuing devices 110 and 120. The queue system account is managed by queue management system 140 and stored in account database 150. Once the user has registered or logged in to the queue system account, the queue system account is loaded at the corresponding queuing device and account information is temporarily stored in device memory 114 and 124. Account information temporarily stored in device memory 114 and 124 may include user preferences, payment information associated with a digital wallet, and queuing device identifiers. The user may update the user preferences before entering the queue or while the queuing device is in the queue, at user interface 112 and 122. The user preferences indicate to queue management system 140 the conditions the user would like to have met in order to exchange positions in the queue with second queuing device 120. The conditions may include factors such as time and cost. The queue system account for each user may store identifying information, such as a name, an e-mail, an address, an account number. Additionally, the queue system account may store identifying information of the queuing device that may be transmitted to another queuing device to confirm an exchange in position in the queue. This queuing device identifying information may include license plate number, driver's license number, registration number, device serial number, or similar forms of identifying information. For example, queuing device identification information may also include physical location and/or relative position information. Users may provide consent to the information that is recorded and/or stored.

In some embodiments, queuing devices 110, 120 may be a dedicated device. For example, this may be a wearable device that may be persistent and/or bound to a user. This may include a theme park wristband, a concert venue lanyard, and/or other wearable devices. In some embodiments, the queuing device 110, 120 may not use a login and/or verification process. Rather, queue management system 140 may use an identifier and/or credentials corresponding to the queuing device 110, 120 for identification.

Queuing devices 110 and 120 may also include device memory 114 and 124. Device memory 114 and 124 may store digital wallet service information associated with the queue system account. A digital wallet service may be used to settle a transaction between first queuing device 110 and second queuing device 120 after an exchange in position in the queue has occurred between queuing devices 110 and 120. Device memory 114 and 124 may include payment information and passwords associated with the digital wallet service information associated with the corresponding queue system account (e.g., associated with a user of the queue system account). For example, the digital wallet may include payment card information. The payment card may be associated with a primary account number (PAN). According to aspects of this disclosure, the PAN may be tokenized for security. According to aspects of this disclosure, the PAN associated with the queue system account may be stored by account database 150. According to aspects of this disclosure, monetary assets may be transferred between payment accounts associated with the digital wallet service information stored in device memory 114 and 124. For example, digital wallet service information may identify a digital wallet. The digital wallet may correspond to a blockchain wallet, asset account, financial account, Central Bank Digital Currency (CBDC) wallet, government and/or state issued digital wallet, private wallet, business wallet, and/or other digital accounts capable of settling transactions, such as microtransactions. These transactions may occur and/or be settled in real-time.

In aspects, the value exchanged between the digital wallets may be in the form of a digital currency. A digital currency is a form of money that exists only in electronic form and is not backed by any physical commodity or legal tender. Digital currencies may be advantageous because they typically involve very low, near zero, transaction fees. These very low transaction fees may enable microtransactions to take place. Digital currencies may be created, stored, transferred, and exchanged using cryptography, peer-to-peer networks, and/or software protocols. Some examples of digital currencies are cryptocurrencies, such as Bitcoin and Ethereum, which operate on decentralized and distributed ledgers, and stablecoins, which are pegged to other assets or currencies to reduce volatility.

A central bank digital currency (CBDC) is a type of digital currency that is issued and regulated by a central bank as a legal tender and a liability of the central bank. A CBDC may be designed to have similar features and functions as cash, such as accessibility, anonymity, and finality, or to have additional capabilities, such as programmability, traceability, and interoperability. A CBDC may be implemented using different technologies and architectures, such as token-based or account-based, centralized or decentralized, wholesale or retail, and online or offline. Some examples of CBDC projects are the digital yuan in China, the e-krona in Sweden, and the sand dollar in the Bahamas.

In some aspects, communication interfaces 116 and 126 facilitate communication between first queuing device 110 and second queuing device 120. This may occur as direct wireless communications between the queuing devices 110 and 120 and/or may occur via network 130. Additionally, communication interfaces 116 and 126 may facilitate communication between queuing devices 110 and 120 and queue management system 140, via network 130. In some embodiments, communication interfaces 116 and 126 may also be used in a mesh network to route communications between a queueing devices 110 and 120 and queue management system 140. For example, first queuing device 110 may communicate with queue management system 140 via other queueing devices. These other queuing devices may pass connection and data from first queuing device 110 to queue management system 140. These other queueing devices may or may not include second queueing device 120. For example, in a system where second queueing device 120 is a counterparty to a transaction, there may be less trust between the two queuing devices 110, 120. First queuing device 110 may be wary that second queueing device 120 could modify and/or alter communications for their benefit. In this case, if first queuing device 110 communicates with queue management system 140 via a mesh network configuration, first queuing device 110 may transmit communications to other queuing devices (not pictured). Queuing devices 110, 120 may communicate with other queuing devices and/or queue management system 140 via communication interfaces 116 and 126.

Communication interfaces 116 and 126 may use a communication protocol (e.g., Ultra-wideband (UWB), Wi-Fi Direct, peer-to-peer Wi-Fi, Nearby Share, Multipeer Connectivity, infrared, etc.) to facilitate a peer-to-peer, ad hoc, and high-speed network) to facilitate communication between queuing devices 110 and 120. Ultra-wideband is a radio technology that can use a very low energy level for short-range, high-bandwidth communications over a large portion of the radio spectrum. In some aspects, the communication protocol may be a low latency/high-speed peer-to peer-connection. utilizing a peer-to-peer connection reduces the network resources required to accommodate various queuing environments that might have a large volume of queuing devices in a single queue, such as vehicles on a highway.

In some aspects, first queuing device 110 is detected and/or identified via the communication module 126 of second queuing device 120, and vice versa. First queuing device 110 may transmit a queuing device identifier to second queuing device 120, and vice versa. The identifier associated with queuing devices 110 and 120 may be tokenized and/or may depend on the type of environment queuing system 100 is operating in. For example, in a highway based queuing system the tokenized identifier may be a license plate number, transponder, driver's license number, registration number, and/or other vehicle identifier.

For example, if the user preference indicates the user will manually determine first queuing device 110 has exchanged positions in the queue with second queuing device 120, then the queuing device identifier may be a visual identifier such as a license plate number. The user may confirm that first queuing device 110 has exchanged positions with second queuing device 120 by recognition of the queuing identifier. The user may then supply an input to user interface 122 to confirm the exchange. The same process may also be used for queuing device 110 to determine the exchange in position with second queuing device 120. In this case, user interface 112 and communication interface 116 may be used.

Position sensors 118 and 128 may use the available infrastructure of queuing devices 110 and 120 to autonomously verify a change in relative position. Data from position sensors 118 and 128 may indicate an exchange in position in the queue has occurred. For example, in a highway based queuing system position sensor 118 may access the sensor system (e.g. the blind spot detection system using ultrasonic or radar sensors, self-driving cars using LIDAR, front, rear, side or 360 degree cameras, or a combination of these sensors or systems used in vehicles) of the first queuing device 110 (e.g. user vehicle) to determine when second queuing device 120 (e.g. another user vehicle) has changed position in queuing environment 100A relative to first queuing device 110. Position sensor 118 can verify the relative movement of first queuing device 120 relative to second queuing device 110 in queuing environment 100A. Similarly, position sensor 128 can verify the relative movement of second queuing device 110 relative to first queuing device 120 in queuing environment 100A. For example, in a highway based queuing system, position sensor 118 may use the existing sensor infrastructure of the vehicle to verify the relative movement of second queuing device 120 relative to first queuing device 110. In queuing environment 100A, the relative movement may be a measurable distance because the queue is a physical queue. For example, the queue may be formed with vehicles on a highway or users with queuing devices in a physical line.

In some aspects, communication interfaces 116 and 126 may enable position sensors 118 and 128 to communicate detected information between queuing devices 120 and 110, respectively. Queuing devices 110 and 120 may have a queuing device identifier. The queuing device identifier may be associated with the corresponding queue system account and stored in queue system account database 150. When the transaction amount is accepted for queuing devices 110 and 120, queue management system 140 may transmit the queuing device identifier corresponding to first queuing device 110 to second queuing device 120 and the queuing device identifier corresponding to second queuing device 120 to queuing device 110. When the exchange in position occurs, communication interface 116 transmits the queuing device identifier of queuing device 110 to queuing device 120. Queuing device 120 in turn confirms that the transmitted queuing device identifier is the same queuing device identifier queuing device 120 received from queue management system 140. The same process can also be executed by queuing device 110.

For example, the exchange in position in the queue of queuing devices 110 and 120 may be automatically confirmed by queuing devices 110 and 120 using communication interfaces 116 and 126 and position sensors 118 and 128. Communication interfaces 116 and 126 may transmit the queuing device identifier and position sensors 118 and 128 may verify the change in position in the queue by using the existing sensors and infrastructure of queuing devices 110 and 120 to determine when another queuing device is moving position relative to first queuing device 110 or second queuing device 120.

In some aspects, queuing device 110 may use a different method than queuing device 120 to determine a change in relative movement has occurred and there was an exchange in position in the queue. For example, first queuing device 110 may use communication interface 116 and position sensor 118 to automatically confirm the change in relative position between queuing devices 110 and 120. Queuing device 120 may use position sensor 128 to determine there was a change in relative movement and use communication interface 126 to manually confirm the change in relative position between queuing device 110 and queuing device 120. Additionally, queue management system 140 may request, via network 130, other queuing devices in queuing environment 100A that are not involved in the transaction to verify the relative movement of one or both of queuing devices 110 and 120 to determine that an exchange in position in the queue occurred.

In some aspects, communication interfaces 116 and 126 may additionally enable peer-to-peer wireless transfer of the value of the transaction between queuing devices 110 and 120 using digital wallet service information stored in device memory 114 and 124. The transaction may be settled in real-time for the accepted transaction amount. In some aspects, the transaction is a microtransaction. Microtransactions may allow the queuing devices 110, 120 to exchange position in the queue multiple times according to the user preferences indicated at user interface 112 and 122, respectively.

Communication interfaces 116 and 126 may also implement security protocols to provide secure identifiers, transaction information, and/or communications. Encryption, authentication, identity verification, and/or other security protocols would be used to ensure that queuing device identifiers being transmitted or used are accurate and/or legitimate. For example, the security protocols would provide protections against device identifiers being counterfeited, spoofed, replayed, and/or used without permission by bad actors.

Queue management system 140 manages the queue system accounts of various users. Users may register a queue system account with queue management system 140 via network 130. In addition to the user preferences and queuing device identifier, user payment information may be associated with the queue system account. The user may register one or more bank accounts to the queue system account and/or provide parameters specifying usage of each of the one or more bank accounts. The bank account information may be associated with a digital wallet service. The digital wallet information may be transmitted to queuing devices 110 and 120 when the users login at queuing devices 110 and 120, respectively. In some aspects, the digital wallet service may link the queue system account to a virtual card token in queue management system 140.

In some aspects, queuing devices 110 and 120 may be associated with multiple queue system accounts. For example, the user can login to one or more devices capable of joining the queue and acting as a queuing device with the user's corresponding queue system account.

In some embodiments, queue management system 140 may implement countermeasures to prevent Sybil attacks and/or other attacks where a malicious actor attempts to create a large number of identities or accounts. For example, queue management system 140 may request a valid funding source and/or a nominal registration fee when registering a queue system account. The fee may be a microtransaction. This may discourage a threat actor from attempting to register hundreds or thousands of accounts. For example, the threat actor may face rapidly mounting costs that may discourage them from creating fake accounts. This may make the process economically unfeasible in terms of cost and time. In some embodiments, queue management system 140 may also use functional identity attestations and/or confirmations to prevent threat actors.

Queue system account information associated with queuing devices 110 and 120 may be stored in account database 150. In some aspects, queuing devices 110 and 120 may use software applications installed on queuing devices 110 and 120, respectively, to facilitate transmission of location and/or calendar information that may affect user preferences for the queue. For example, queuing devices 110 and 120 may share data with queue management system 140 from other applications installed on queuing devices 110 and 120, such as GPS tracking applications or calendar applications.

Account database 150 stores queue system account information for each user and user preference data. This data may correspond to time preferences and/or may include timestamps indicating when queuing devices 110, 120 join a particular queue. The preferences may indicate when a queuing device 110, 120 is expected to join a queue. Account database 150 stores user preferences received at queue management system 140 from user interfaces 112 and 122. The information associated with the queue system account may be accessed each time queuing devices 110 and 120 connects to queue management system 140 via network 130. In some aspects, device memory 114 and 124 may be persistent and/or store queue system account information in a persistent manner as well. In some embodiments, the account information may also include user history and/or information corresponding to previous usage of a queuing device 110, 120 and/or queue management system 140. Queue management system 140 may also track usage metrics, engagement scores, loyalty program data, and/or user status tiers. For example, a high usage user may be granted a VIP tier or designation. In some embodiments, queue management system 140 may adjust price calculations and/or queue prioritization for users based on the user's history and/or usage metrics.

Queue management system 140 may include user position tracking system 142 and/or user suggestion system 144. User position tracking system 142 tracks the position of each queuing device in queuing environment 100A. User position tracking system 142 may receive data from applications installed on queuing devices 110 and 120. User suggestion system 144 may use the position data from user position tracking system 142 and user preferences to suggest a queue for a particular queuing device to join and/or to suggest a potential exchange of position between first queuing device 110 and second queuing device 120.

For example, the first queuing device 110 and/or the queuing management system 140 may use GPS information, position sensor data, and/or detection data from other queuing devices to determine a queue for the first queuing device 110. In some embodiments, queue management system 140 queries first queuing device 110 for location and/or position information. Queue management system 140 may use this information to suggest a particular queue and/or to place first queuing device 110 into a particular queue automatically. The user may automatically join and/or choose to join the detected and/or suggested queue. Queue management system 140 may also automatically place the first queuing device 110 in a particular position in the queue according to the location and/or position information. In some embodiments, queue management system 140 may also triangulate the position of the first queuing device 110 using data from other nearby queueing devices. This data may include positioning data and/or sensor data. For example, as further described in this disclosure, queue management system 140 may identify a starting position and/or queue for the first queuing device 110 using positioning data and/or sensor data similar to the data used to verify that positions have been exchanged between queuing devices. This may occur automatically.

User suggestion system 144 may additionally suggest transaction amount for the exchange of position in queuing environment 100A. The suggested transaction amount may be based on the user preferences associated with the queue system accounts logged in at queuing devices 110 and 120. For example, user suggestion system 144 may suggest first queuing device 110 exchange position in the queue with second queuing device 120 for a specified dollar amount. The suggested dollar amount may depend on user preferences such as speed, time, economy, profit, cost, and/or other user-defined preferences. The user input preferences of first queuing device 110 and second queuing device 120 may contribute to the suggested transaction amount presented at user interface modules 112 and 122 from user suggestion system 144 of queue management system 140.

For example, the user preferences from user interface 112 of first queuing device 110 may indicate that the user has a short timeline and is willing to pay a certain transaction amount to increase their position in a queue. The user input preferences of second queuing device 120 may indicate that the user is not on a short timeline. For example, the user of second queuing device 120 does not need or does not have a desire to increase the position of second queuing device 120 in the queue. The second queuing device 120 may also include a desired profit amount for exchanging positions. In this case, if the desired profit for exchanging position in the queue is within the budget of queuing device 110, then user suggestion system 144 may suggest a transaction amount to queuing devices 110 and 120 corresponding to second queuing device 120 yielding its position in the queue to first queuing device 110. In some embodiments, automated market maker (AMM) and/or a coincidence of wants (CoW) calculations, algorithms, and/or processes may be used as well.

The queuing environment 100A may include a network 130. Network 130 may be a wireless network and/or a combination of wired and wireless networks. For example, network 130 may include a packet-switched network (e.g., Internet protocol-based network), a non-packet switched network (e.g., quadrature amplitude modulation-based network), and/or the like. According to aspects of this disclosure, network 130 may include network adapters, switches, routers, modems, and the like connected through wireless links (e.g., radiofrequency, satellite) and/or physical links (e.g., fiber optic cable, coaxial cable, Ethernet cable, or a combination thereof). According to aspects of this disclosure, network 130 may include public networks, private networks, wide area networks (e.g., Internet), local area networks, and/or the like. According to aspects of this disclosure, network 130 may provide and/or support communication from a telephone, cellular phone, modem, and/or other electronic devices associated with queuing devices 110 and 120 to and throughout the queuing environment 100A. For example, queuing environment 100A may include and support communications between queuing management system 140 and queuing devices 110 and 120 via network 130.

FIG. 1B depicts a block diagram of an electronic queuing environment 100B, according to aspects. Electronic queuing environment 100B includes queuing devices 110 and 120, network 130, queue management system 140, and account database 150.

Electronic queuing environment 100B may correspond to a scenario where queuing devices 110 form an electronic queue. For example, the electronic queue may correspond to ticket sales on a website. Users with corresponding queueing system accounts may be placed in a queue prior to being allowed to purchase tickets to a concert, show, sporting event, and/or other ticketed event. Queue management system 140 may manage the electronic queue to avoid overwhelming ticket system resources in ticket distribution. The users may use queuing devices 110, 120 to join the electronic queue and/or view their corresponding position in the queue. As further explained below, the users may use queuing devices 110, 120 to exchange positions in the queue. Queue management system 140 may facilitate transactions between queue system accounts to facilitate the exchange of monetary value for queue position between users of queuing devices 110, 120.

For example, queue management system 140 includes user position tracking system 142 and user suggestion system 144. User position tracking system 142 tracks the position of each account corresponding to the queuing devices in queuing environment 100B. User position tracking system 142 may manage the electronic queue, manage queue position information, and/or provide queue position information to queuing devices 110, 120. In some aspects, queue management system 140 may facilitate exchanges of positions while a separate system facilitates the electronic queue. In this case, queue management system 140 may receive position information from the other system managing the electronic queue. For example, when the electronic queue is for ticket sales on a website, queue system 140 may communicate via network 130 with the electronic queue and the electronic queue may provide user position tracking system 142 of queue management system 140 position data for each of the queuing devices in the electronic queue. Network 130 may be similar to network 130 as described with reference to FIG. 1A.

In electronic queuing environment 100B, queuing devices 110 and 120 may be a computer system such as computer system 400 described with reference to FIG. 4. For example, queuing devices 110 and 120 may be a smart phone, smart watch, desktop computer, laptop or notebook computer, netbook, tablet, personal digital assistant (PDA), and/or other electronic devices that are capable of entering a digital queue. Queuing devices 110 and 120 may include user interface 112 and 122, device memory 114 and 124, communication interface 116 and 126, respectively. In some aspects, the user registers a queue system account or logs into an existing queue system account on queuing devices 110 and 120. The queue system account is managed by queue management system 140 and stored in account database 150. Once the user has registered or logged in to the queue system account, the queue system account is loaded at the corresponding queuing device and account information is temporarily stored in device memory 114 and 124. Account information temporarily stored in device memory 114 and 124 may include user preferences, payment information associated with a digital wallet, and queuing device identifiers. The user may update the user preferences before entering the queue or while the queuing device is in the queue, at user interface 112 and 122. The user preferences indicate to queue management system 140 the conditions the user would like to have met in order to exchange positions in the queue with second queuing device 120. The conditions may include factors such as time and cost. The queue system account for each user may store identifying information, such as a name, an e-mail, an address, an account number. Additionally, the queue system account may store identifying information of the queuing device that queue management system 140 can use to confirm the exchange in position in the queue of queuing devices 110 and 120.

In some embodiments, the queue system account may also store and/or use queuing device identifying information in the context of ticket sales. For example, in the context of online ticket sales, this information may be used to determine an initial position of the user account and/or a price or priority for exchanging positions. In some embodiments, data may also be gathered from other systems and/or connections. For example, users may consent to having data gathered from a streaming service, such as a video or music streaming service, and/or from a social media platform. For example, if the user is a fan of a particular band or musical act, the data may be gathered to indicate fan may engagement. Such information may be used to provide preferential queue positions and/or may be used to provide different or cheaper exchange rates. For example, exchange rates for users trading positions may be modified based on the users'engagement with the particular band or musical act. This engagement may be measured based on the data gathered from the social media platforms and/or streaming services.

Device memory 114 and 124 may store digital wallet service information associated with the queue system account. A digital wallet service may be used to settle a transaction between first queuing device 110 and second queuing device 120 after an exchange in position in the queue has occurred between queuing devices 110 and 120. Device memory 114 and 124 may include payment information and passwords associated with the digital wallet service information associated with the corresponding queue system account (e.g., associated with a user of the queue system account). For example, the digital wallet may include payment card information. The payment card may be associated with a primary account number (PAN). According to aspects of this disclosure, the PAN may be tokenized for security. According to aspects of this disclosure, the PAN associated with the queue system account may be stored by account database 150. According to aspects of this disclosure, monetary assets may be transferred between payment accounts associated with the digital wallet service information stored in device memory 114 and 124. For example, digital wallet service information may identify a digital wallet. The digital wallet may correspond to a blockchain wallet, asset account, financial account, and/or other digital account capable of settling transactions, such as microtransactions. These transactions may occur and/or be settled in real-time.

Communication interfaces 116 and 126 may facilitate communication between first queuing device 110 and queue management system 140 via network 130 and second queuing device 120 and queue management system 140 via network 130. Queue management system 140 may communicate changes in electronic queue position to queuing devices 110 and 120. Communication interfaces 116 and 126 may receive queue position information. Communication interfaces 116 and 126 may also receive digital wallet service information from queue management system 140 to settle the transaction between first queuing device 110 and second queuing device 120. In some aspects, the communication between queuing devices 110, 120 and queue management system 140 may occur using network 130. This may use communications protocols in the manner described with reference to FIG. 1A.

For example, first queuing device 110 may exchange position in the queue with second queuing device 120. This may occur when an account corresponding to first queuing device 110 exchanges positions with an account corresponding to second queuing device 120. First queuing device 110 and second queuing device 120 may communicate the desire to exchange positions in the queue management system 140. For example, queue management system 140 may transmit data to queuing device 110 to display a graphical user interface prompt. The prompt may provide an offer to the user to change positions in the electronic queue for a particular transaction and/or microtransaction fee or exchange. For example, the exchange may be exchange positions between accounts corresponding respectively to queuing devices 110 and 120. A first account corresponding to queuing device 110 may take the place of a second account corresponding to queuing device 120 in the electronic queue. A transaction amount may be transferred from the first account to the second account in response to this exchange of position. The change in position in the queue may be entered manually, for example the users first queuing device 110 and second queuing device 120 may confirm their desire to exchange positions in the queue via user interfaces 112 and 122. Queue management system 140 then exchanges the positions and/or verifies that they correctly exchanged position if the electronic queue is managed by a separate system. Additionally, queue management system 140 may autonomously verify the exchange in position, for example through the source code of the electronic queue or through communication with the electronic queue.

In some embodiments, the graphical user interface may include a dial or a slider. This may include a moveable marker on a spectrum. The spectrum may depict a correlation between a particular length in time and a cost. For example, a user may select to pay a higher cost to spend less time in the queue. Similarly, a user may select a lower cost and/or choose to receive funding to spend more time in the queue.

In some embodiments, the display and/or selection of a positional exchange amount may occur prior to a user operating a vehicle. For example, the user may select a positional exchange amount prior to embarking on a journey. In some embodiments, the display and/or selection may occur while the vehicle in motion. In this case, protections against distracting drivers may be implemented. For example, audio may be used and/or voice commands may be used to accept a suggested positional exchange amount. In some embodiments, a temporary screen lockout may occur to prevent a driver from shifting his or her focus to the user interface 112. The temporary screen lockout may occur when multiple interactions within a predetermined time window are detected. These measures to limit driver interactions while a vehicle is in motion may promote safety and/or minimize driver distractions.

Queue management system 140 manages the queue system accounts of various users. A user may register a queue system account with queue management system 140 via network 130. In addition to the user preferences and queuing device identifier, user payment in formation may be associated with the queue system account. The user may register one or more bank accounts to the queue system account and/or provide parameters specifying usage of each of the one or more bank accounts. The bank account information may be associated with a digital wallet service. The digital wallet information may be transmitted to queuing devices 110 and 120 when the users login at queuing devices 110 and 120, respectively. In some aspects, the digital wallet service may link the queue system account to a virtual card token in queue management system 140.

In some aspects, queuing devices 110 and 120 may be associated with multiple queue system accounts. For example, the user can login to one or more devices capable of joining the queue and acting as a queuing device with the user's corresponding queue system account.

Queue system account information associated with queuing devices 110 and 120 may be stored in account database 150. In some aspects, queuing devices 110 and 120 may use software applications installed on queuing devices 110 and 120, respectively, to facilitate transmission of position and/or calendar information that may affect user preferences for the queue. Queue management system 140 may also use other application data and/or observed historical outcomes to aid in providing a suggested exchange condition and/or a time/cost suggestion.

Account database 150 stores queue system account information for each user and user preference data. This data may correspond to time preferences and/or may include timestamps indicating when queuing devices 110, 120 join a particular queue. The preferences may indicate when a queuing device 110, 120 is expected to join a queue. Account database 150 stores user preferences received at queue management system 140 from user interfaces 112 and 122. The information associated with the queue system account may be accessed each time queuing devices 110 and 120 connects to queue management system 140 via network 130. In some aspects, device memory 114 and 124 may be persistent and/or store queue system account information in a persistent manner as well.

Queue management system 140 may include user position tracking system 142 and user suggestion system 144. User position tracking system 142 tracks the position of each queuing device in queuing environment 100B. User position tracking system 142 may receive data from applications installed on queuing devices 110 and 120. Additionally, user position tracking system may receive queuing device position information from the electronic queue. For example, when the electronic queue is for ticket sales on a website, queue system 140 may communicate via network 130 with the electronic queue and the electronic queue may provide user position tracking system 142 of queue management system 140 position data for each of the queuing devices in the electronic queue.

User suggestion system 144 may use the position data from user position tracking system 142 and user preferences to suggest a potential exchange of position between first queuing device 110 and second queuing device 120. User suggestion system 144 may additionally suggest transaction amount for the exchange of position in electronic queuing environment 100B. The suggested transaction amount may be based on the user preferences associated with the queue system accounts logged in at queuing devices 110 and 120. For example, user suggestion system 144 may suggest first queuing device 110 exchange position in the queue with second queuing device 120 for a specified dollar amount. The suggested dollar amount may depend on user preferences such as time, economy, profit, cost, and/or other user-defined preferences. The user input preferences of first queuing device 110 and second queuing device 120 may contribute to the suggested transaction amount presented at user interface 112 and 122 from user suggestion system 144 of queue management system 140.

For example, the user preferences from user interface 112 of first queuing device 110 may indicate that the user has a short timeline and/or wishes to purchase tickets before they become unavailable. The preference may indicate a willingness to pay a certain transaction amount to increase their position in a queue. The user input preferences of second queuing device 120 may indicate that the user is not on a short timeline and/or has less of a desire to obtain tickets. For example, the user of second queuing device 120 does not need or does not have a desire to increase the position of second queuing device 120 in the queue. The second queuing device 120 may also include a desired profit amount for exchanging positions. In this case, if the desired profit for exchanging position in the queue is within the budget of queuing device 110, then user suggestion system 144 may suggest a transaction amount to queuing devices 110 and 120 corresponding to second queuing device 120 yielding its position in the queue to first queuing device 110.

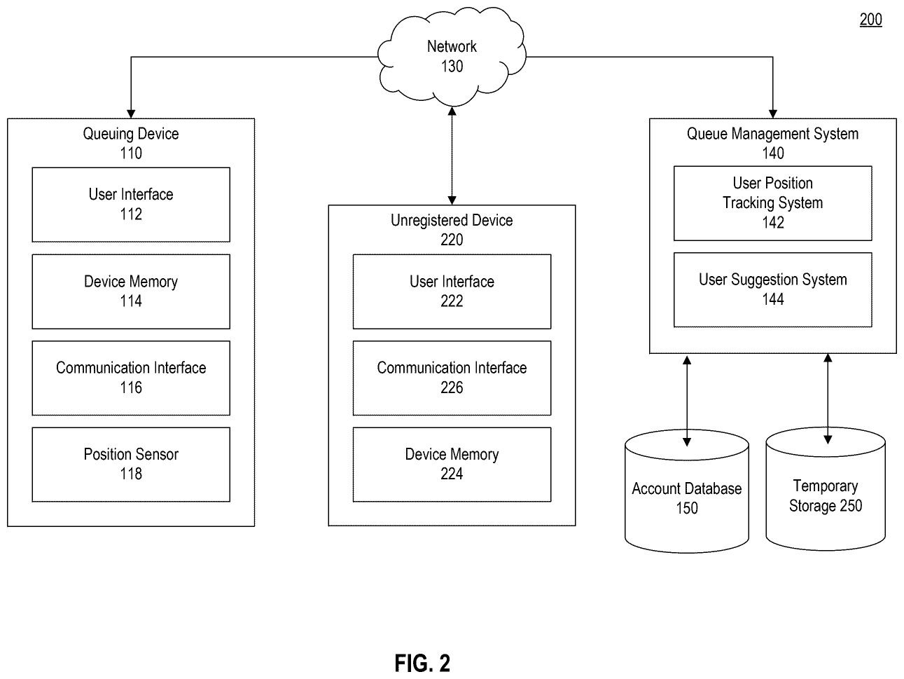

FIG. 2 depicts a block diagram of a queuing environment 200 that accounts for unregistered devices, according to aspects. Unregistered devices refer to devices that are similar to the queuing devices described with respect to FIGS. 1A and 1B, but are not registered with the queue management system 140. As a result, the unregistered devices do not have corresponding digital wallets and the queue management system 140 does not have identifying information corresponding to the unregistered devices and/or users corresponding to the unregistered devices. Thus, queuing environment 200 describes a situation where a registered queuing device (e.g., first queuing device 110) encounters unregistered devices (e.g., unregistered device 220). The description below with respect to FIG. 2 will describe aspects in which the two devices can interact to facilitate a transfer of an exchange amount using the queue management system 140, based on exchanged queue positions. Thus, the description with respect to FIG. 2 allows the queue management system 140 to expand the range of devices that it can operate with.

In aspects, unregistered device 220 may be similar to queuing devices 110 and 120 described with respect to FIGS. 1A and 1B, and can have the same or similar components. For example, unregistered device 220 can have a user interface 222, a communication interface 226, and a device memory 224, all of which can function similar to their analogs described with respect to FIGS. 1A and 1B. While not shown in FIG. 2, unregistered device 220 can optionally have a position sensor similar to position sensor 118 and 128 of FIGS. 1A and 1B, which can operate in a similar manner. However, for the purposes of discussion with respect to FIG. 2, it is assumed that unregistered device 220 does not have a position sensor.

In aspects, similar to what was described with respect to FIGS. 1A and 1B, the first queuing device 110 and the unregistered device 220 can interact relative to one another on a road, at an event, in a line, or other queuing environment in which their physical and/or electronic positions may be exchanged. In aspects, the queue management system 140 can monitor these interactions by receiving position data from the sensors (e.g., position sensor 118), communication interface 116, and/or integrated applications (e.g., GPS applications) of the first queuing device 110.

For example, the position sensor 118 and/or the communication interface 116 can transmit position data of the first queuing device 110 relative to the unregistered device 220 to the user position tracking system 142 of the queue management system 140. Because the first queuing device 110 is registered with the queue management system 140 it may be coupled/connected to the position sensor 118 and/or communication interface 116 of the first queuing device 110 to monitor its position relative to other devices as described with respect to FIGS. 1A and 1B.

In aspects, based on the position data obtained by the queue management system 140, the queue management system 140 can determine whether the first queuing device 110 and the unregistered device 220 have exchanged physical and/or electronic positions. In aspects, the queue management system 140 can further make determinations about the relative positions of the two devices. For example, the queue management system 140 can determine whether the first queuing device is in a more favorable position (physical or electronic), less favorable position, or in a neutral position relative to where it had been prior to any exchanged positions. More favorable refers to the first queuing device 110 moving ahead of the unregistered device 220 in a queue or a physical position. Less favorable refers to the first queuing device 110 falling behind the unregistered device 220 in a queue or a physical position. Neutral refers to the first queuing device 110 staying in the same position or near same position relative to unregistered device 220 in a queue or a physical position. Similar techniques as described with respect to FIGS. 1A and 1B may be used to make these determinations, by for example, using the position sensor 118, communication interface 116, and any integrated applications on the first queuing device 110 to determine relative positions of the devices with respect to one another.

In aspects, if the queue management system 140 determines that the unregistered device 220 has yielded to the first queuing device 110, by for example performing a maneuver to cause the first queuing device 110 to obtain a more favorable position (either physically or electronically), the queue management system 140 can reward the unregistered device 220. The reward has two primary purposes. First, is to encourage cooperation between the devices by incentivizing the unregistered device 220 to perform maneuvers to allow devices that request priority positions to move into those positions, if the unregistered device 220 does not need to be in a priority position itself. Second, is to encourage users corresponding to the unregistered device 220 to register the unregistered device 220 with the queue management system 140, as will be described below.

In order for the unregistered device 220 to access the reward, the unregistered device 220 will be required to register with the queue management system 140. Thus, the reward can also serve as a way to increase the eco-system of devices registered with the queue management system 140.

In aspects, the reward may be an exchange amount. The exchange amount may be in the form of a fiat currency, a digital currency, a coupon, a credit, a promotion, etc. In aspects, the reward can include transferring an exchange amount from a first digital wallet corresponding to the first queuing device 110 to a temporary storage 250 of the queue management system 140 for a user corresponding to the unregistered device 220 to retrieve. The temporary storage 250 refers to a database, a memory location, a ledger, an escrow system, or similar mechanism of the queue management system 140 that can hold the exchange amount until a user of the unregistered device 220 retrieves it. How the temporary storage 250 is implemented will depend on the form and nature of the exchange amount. For example, if the exchange amount is in the form of a digital currency, the temporary storage 250 may be, for example, a digital ledger (e.g., blockchain ledger). If the exchange amount is in the form of a fiat currency, the temporary storage 250 may be, for example, a database or server that can record and store the amount of the fiat currency. If the exchange amount is in the form of a coupon or credit, the temporary storage 250 may be, for example, a software application or wallet custom built to store the coupon or credit. In aspects, the temporary storage 250 can integrate with digital wallets of users of the queue management system 140 to send or receive funds to and from the digital wallets.

In aspects, in order to encourage users of the unregistered device 220 to register with the queue management system 140 and become part of the community of devices involved in the marketplace of transactions facilitated by the queue management system 140, the queue management system 140 can obtain contact information of a user corresponding to the unregistered device 220. In aspects, the contact information can include at least e-mail address, a phone number, a social media account, a name, an address, or other identifying information of a user.

In aspects, the contact information may be obtained via device identifiers, as described with respect to FIGS. 1A and 1B. For example, in a scenario where the unregistered device 220 is a vehicle, the device identifier may be, for example, an identified license plate number. The license plate number may be identified using the position sensor 118 of the first queuing device 110. The queue management system 140 can then do a lookup using the license plate number via a third-party source, for example, a public database, a governmental database (e.g., motor vehicle department databases), a private database, a data broker, and/or by crawling the Internet, in order to identify a user corresponding to the license plate. In aspects, the queue management system 140 can integrate with third-party source to retrieve the data. The integration may be via an application programming interface (API), by crawling the third-party source, by subscribing to a service of the third-party to retrieve the contact information, or by other similar means. A person of skill in the art reading this disclosure will recognize the various integrations that may be made with the third-party source.

In other examples, such as those where involving electronic queues where the unregistered device 220 has been used to purchase tickets for a ticketed event or an event where pre-registration is required such as a concert, show, sporting event, and/or other ticketed event, the device identifier may be contact information given by a user when purchasing the ticket or pre-registering for the event. In aspects, when purchasing the ticket, cookies and/or tracking software may be downloaded onto the unregistered device 220, or may be integrated with the ticket in the case of an electronic ticket, or may be part of an application used to purchase the ticket or pre-register for the event. The cookies and/or tracking software can track and identify the unregistered device 220 throughout the event and assist the queue management system 140 to determine relative changes in positions between devices. If during the event it is determined that the unregistered device 220 has yielded to the first queuing device 110, the queue management system 140 can identify the user corresponding to the unregistered device 220 based on the contact information given by the user, and can facilitate transfer of the exchange amount to the temporary storage 250.

In aspects, based on the obtained contact information, the queue management system 140 can generate a message to the user of the unregistered device 220. The message can notify the user of availability of the exchange amount to retrieve. In aspects, upon generating the message, the queue management system 140 can transmit the message to the user of the unregistered device 220, or can initiate transmission of the message to the user of the unregistered device via any appropriate manner based on the contact information retrieved. For example, the message may be in the form of an e-mail, a phone call, a physical mail/correspondence, a push notification, or a Short Message Service (SMS) message. In aspects, the message can indicate to the user of the unregistered device 220 that the exchange amount is ready for the user to retrieve. In aspects, the message can further include a hyperlink generated that the user can use to register the unregistered device 220 with the queue management system 140. The user of the unregistered device 220 can interact with the hyperlink by clicking, using, or following the link using, for example, the user interface 222 to a registration page/website of the queue management system 140 to register the unregistered device 140. Once registered, the user can retrieve the exchange amount.

In aspects, as a part of the registration, the user may be assigned a digital wallet by the queue management system 140. In aspects, the user can link/connect the digital wallet to a financial account of an institution, such that the exchange amount and further amounts obtained from future transactions may be transferred to the financial account.

The queue management system 140 described with respect to FIGS. 1A, 1B, and 2 provides a novel technological solution for reducing the time spent in a queue and traffic, and balancing the different interests of individuals by providing mechanisms to facilitate the exchange of queue positions. the queue management system 140 also provides a unique way of incentivizing individuals to yield to one another in queuing environments by facilitating transactions between devices exchanging positions. Using the processes and components described, the queue management system 140 also provides a technological way to control and shape user/device behavior because it provides a unique way of incentivizing users/devices to yield to one another so that users/devices needing higher priority in queuing situations are afforded the higher priority positions by allowing transactions and exchanges in value between users/devices. This ability to shape traffic in queuing scenarios has significant effects on the time spent by individuals or devices in a queue and traffic because it allows for those that need to move through these queues and traffic faster than those that do not. As a result, traffic congestion in various scenarios may be alleviated.

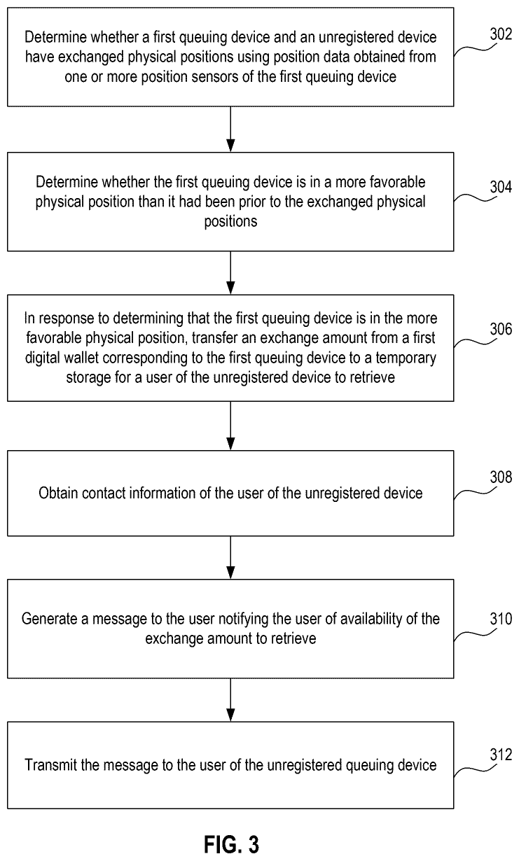

FIG. 3 depicts a flowchart illustrating a method 300 of operating a queue management system 140 to account for unregistered devices (e.g., unregistered device 220), according to aspects. Method 300 may be performed by one or more computing devices of the queue management system 140 described with respect to FIGS. 1A, 1B, and 2. The queue management system 140 can operate in conjunction with one or more computing devices of the first queuing device 110 and the unregistered device 220 to perform the functions described.

In step 302, the queue management system 140 can determine whether a first queuing device 110 and an unregistered device 220 have exchanged physical positions using position data obtained from one or more position sensors (e.g., position sensor 118) of the first queuing device 110. In step 304, a determination is made whether the first queuing device 110 is in a more favorable physical position than it had been prior to the exchanged physical positions. In step 306, in response to determining that the first queuing device 110 is in the more favorable physical position, the queue management system 140 can transfer or facilitate a transfer of an exchange amount from a first digital wallet corresponding to the first queuing device 110 to a temporary storage 250 for a user of the unregistered device 220 to retrieve. In step 308, the queue management system 140 can obtain contact information of the user of the unregistered device 220. In step 310, a message may be generated to the user notifying the user of availability of the exchange amount to retrieve. In step 312, the message may be transmitted to the user of the unregistered queuing device.

In aspects, the first queuing device 110 and the unregistered device 220 can be vehicle computer systems. In aspects, the first queuing device 110 and the unregistered device 220 can be mobile communication devices.

In aspects, the message comprises: an e-mail, a phone call, a physical mail/correspondence, a push notification, or a Short Message Service (SMS) message.

In aspects, the exchange amount comprises: a fiat currency, a digital currency, a coupon, or a credit.

In aspects, the queue management system 140 can generate as a part of the message, a hyperlink for the user to register the unregistered device 220 to the queue management system 140.

In aspects, transferring the exchange amount from the first digital wallet to the temporary storage 250 is done in real-time from when the first queuing device 110 is determined to be in the more favorable physical position than it had been prior to the exchanged physical positions.

It is to be appreciated that not all steps may be needed to perform the disclosure provided herein. Further, some of the steps may be performed simultaneously, or in a different order than shown in FIG. 3, as will be understood by a person of ordinary skill in the art.

FIG. 4 depicts an example computer system used to implement the queue management system 140, according to aspects.

Computer system 400 may include one or more processors (also called central processing units, or CPUs), such as a processor 404. Processor 404 may be connected to a communication infrastructure or bus 406. In some embodiments, processor 404 may include an encryption system. This may be used to provide transaction security and/or to pass secure and/or trusted data. In some embodiments, the encryption system may be a physical secure element chip. The encryption system may also use a kernel and/or other certified software element to provide encryption and/or decryption of communications and/or messages. Such functionality may be implemented using one or more processors, such as processor 404.

Computer system 400 may also include user input/output device(s) 403, such as monitors, keyboards, pointing devices, etc., which may communicate with communication infrastructure 406 through user input/output interface(s) 402.

Processor 404 may be a central processing unit (CPU) or graphics processing unit (GPU). In an aspect, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 may include a computer usable or readable storage device having stored thereon computer software (control logic) and/or data. Removable storage unit 418 may be a floppy disk, magnetic tape, compact disk, DVD, optical storage disk, and/pr any other computer data storage device. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over network 130 of FIGS. 1A, 1B, and 2, which may be wired and/or wireless (or a combination thereof), and which may include any combination of LANs, WANs, the Internet, etc. Control logic and/or data may be transmitted to and from computer system 400 via network 130.

Computer system 400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 300 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some aspects, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

Based on the teachings contained in this disclosure, it will be apparent to persons skilled in the relevant art(s) how to make and use aspects of this disclosure using data processing devices, computer systems and/or computer architectures other than that shown in FIG. 4. In particular, aspects can operate with software, hardware, and/or operating system implementations other than those described herein.

While this disclosure describes exemplary aspects for exemplary fields and applications, it should be understood that the disclosure is not limited thereto. Other aspects and modifications thereto are possible, and are within the scope and spirit of this disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries may be defined as long as the specified functions and relationships (or equivalents thereof) are appropriately performed. Also, alternative aspects can perform functional blocks, steps, operations, methods, etc. using orderings different than those described herein.

References herein to “one aspect,” “an aspect,” “an example aspect,” or similar phrases, indicate that the aspect described can include a particular feature, structure, or characteristic, but every aspect can not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein. Additionally, some aspects may be described using the expression “coupled” and “connected” along with their derivatives. These terms are not necessarily intended as synonyms for each other. For example, some aspects may be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary aspects, but should be defined only in accordance with the following claims and their equivalents.

What is claimed is:

1. A computer-implemented method, comprising:
determining, by one or more computing devices of a queue management system, whether a first queuing device and an unregistered device have exchanged physical positions using position data obtained from one or more position sensors of the first queuing device;
determining whether the first queuing device is in a more favorable physical position than it had been prior to the exchanged physical positions;
in response to determining that the first queuing device is in the more favorable physical position, transferring an exchange amount from a first digital wallet corresponding to the first queuing device to a temporary storage for a user of the unregistered device to retrieve;
obtaining contact information of the user of the unregistered device;
generating a message to the user notifying the user of availability of the exchange amount to retrieve; and
transmitting the message to the user of the unregistered queuing device.

2. The computer-implemented method of claim 1, wherein the first queuing device and the unregistered device are vehicle computer systems.

3. The computer-implemented method of claim 1, wherein the first queuing device and the unregistered device are mobile communication devices.

4. The computer-implemented method of claim 1, wherein the message comprises: an e-mail, a phone call, a physical mail/correspondence, a push notification, or a Short Message Service (SMS) message.

5. The computer-implemented method of claim 1, wherein the exchange amount comprises: a fiat currency, a digital currency, a coupon, or a credit.

6. The computer-implemented method of claim 1, further comprising generating as a part of the message, a hyperlink for the user to register the unregistered device to the queue management system.

7. The computer-implemented method of claim 1, wherein transferring the exchange amount from the first digital wallet to the temporary storage is done in real-time from when the first queuing device is determined to be in the more favorable physical position than it had been prior to the exchanged physical positions.

8. A non-transitory computer readable medium storing instructions, that when executed by one or more processors of a computing system, cause the computing system to perform operations comprising:
determining, by one or more computing devices of a queue management system, whether a first queuing device and an unregistered device have exchanged physical positions using position data obtained from one or more position sensors of the first queuing device;
determining whether the first queuing device is in a more favorable physical position than it had been prior to the exchanged physical positions;
in response to determining that the first queuing device is in the more favorable physical position, transferring an exchange amount from a first digital wallet corresponding to the first queuing device to a temporary storage for a user of the unregistered device to retrieve;
obtaining contact information of the user of the unregistered device;
generating a message to the user notifying the user of availability of the exchange amount to retrieve; and
transmitting the message to the user of the unregistered queuing device.

9. The non-transitory computer readable medium of claim 8, wherein the first queuing device and the unregistered device are vehicle computer systems.

10. The non-transitory computer readable medium of claim 8, wherein the first queuing device and the unregistered device are mobile communication devices.

11. The non-transitory computer readable medium of claim 8, wherein the message comprises:
an e-mail, a phone call, a push notification, or a Short Message Service (SMS) message.

12. The non-transitory computer readable medium of claim 8, wherein the exchange amount comprises: a fiat currency, a digital currency, a coupon, or a credit.

13. The non-transitory computer readable medium of claim 8, wherein the operations further comprise generating as a part of the message, a hyperlink for the user to register the unregistered device to the queue management system.

14. The non-transitory computer readable medium of claim 8, wherein transferring the exchange amount from the first digital wallet to the temporary storage is done in real-time from when the first queuing device is determined to be in the more favorable physical position than it had been prior to the exchanged physical positions.

15. A computing system comprising:
a memory storing instructions;
one or more processors, coupled to the memory and configured to process the stored instructions to:
determine whether a first queuing device and an unregistered device have exchanged physical positions using position data obtained from one or more position sensors of the first queuing device;
determine whether the first queuing device is in a more favorable physical position than it had been prior to the exchanged physical positions;
in response to determining that the first queuing device is in the more favorable physical position, initiating transfer of an exchange amount from a first digital wallet corresponding to the first queuing device to a temporary storage for a user of the unregistered device to retrieve;
obtain contact information of the user of the unregistered device;
generate a message to the user notifying the user of availability of the exchange amount to retrieve; and
a communication interface, coupled to the memory and configured to process the stored instructions to:
transmit the message to the user of the unregistered queuing device.

16. The computing system of claim 15, wherein the first queuing device and the unregistered device are vehicle computer systems.

17. The computing system of claim 15, wherein the first queuing device and the unregistered device are mobile communication devices.

18. The computing system of claim 15, wherein the message comprises: an e-mail, a phone call, a push notification, or a Short Message Service (SMS) message.

19. The computing system of claim 15, wherein the exchange amount comprises: a fiat currency, a digital currency, a coupon, or a credit.

20. The computing system of claim 15, wherein the one or more processors are further configured to generate as a part of the message, a hyperlink for the user to register the unregistered device to a queue management system.
